(19) United States
(12) Patent Application Publication
(10) Pub. No.: US 2009/0305788 A1
(43) Pub. Date: Dec. 10, 2009

(54) MODIFYING ELECTRONIC GAMES BASED ON PREVIOUS GAME PLAY

(75) Inventors: Manuel Bronstein, Redmond, WA (US); James F. Geist, Jr., Issaquah, WA (US); Matthew Van Gorder, Redmond, WA (US); Gary Hall, Redmond, WA (US); Evan Brandt, Kirkland, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/133,342

(22) Filed: Jun. 4, 2008

(51) Int. Cl. A63F 13/12; A63F 13/02

(52) U.S. Cl. 463/42; 463/43

(57) ABSTRACT

Techniques are disclosed herein for hosting an electronic game over a network during a first scheduled time slot and then, during a later timeslot, hosting a rerun of the game in a way that provides a fresh user experience. The rerun is not simply a replaying of the game, but changes the game to keep the game fresh. However, because substantial portions of the software and data content that implement the game is re-used, a limited set of software and data content can be used for many reruns. Thus, the cost of providing fresh games is kept low.

### BACKGROUND

Games consoles, such as the Xbox 360™ game console, have been used for many years to allow users to play electronic games with others sharing the game console. Such games consoles can also be used to play electronic games with others over a network. As an example, the game console is connected to a game server that controls the game play. Such online game play permits users to interact with many more players than is possible when play is limited to those using the same device. Note that a personal computer (PC) could be used to play multi-player online games instead of a game console and that a PC and game console can participate in the same game session.

Some online games are designed with the intent of having a very large audience. That is, the game becomes more interesting when hundreds, thousands, or even tens of thousands of user play concurrently. Such game play is sometimes referred to as “massively multi-player online gaming.” Some online games have achieved such enormous popularity that a large online audience can be almost guaranteed for at least significant portions of each day.

A drawback of online games is that a player does not know whether there will be a suitable size audience for the online game at the time the user decides to play.

Another drawback of online games is the potential high barrier to entry. Substantial cost is incurred in developing the game content for a new game. For games that become very popular, development costs can be recouped by charging a monthly subscription fee to play the game and/or requiring that the players purchase software to play the game. However, potential providers of new games may be reluctant to enter the market.

### SUMMARY

Techniques are disclosed herein for re-using game content in order to provide fresh game experiences with a limited set of game content. For example, an electronic game is hosted over a network during a first scheduled timeslot and then, during a later timeslot, a rerun of the game is hosted in a way that provides a fresh game experience. The rerun is not simply a replaying of the game, but changes the game content to keep the game playing experience fresh. However, because substantial portions of the game content are re-used, a limited set of game content can be used for many reruns. Thus, the cost of providing a fresh game experience is kept low. Also, note that the electronic game is hosted during scheduled time slots, which helps to achieve a suitable size game playing audience.

In one aspect, a first electronic game is hosted over a network to client devices. Information that is pertinent to the electronic game is collected while the first electronic game is hosted. A modification to the first electronic game is determined based on the information. A second electronic game is hosted based on the modifications to the first electronic game. Because the second game is based on automatically modifying the first game, the game experience is kept fresh.

In another aspect, game content is automatically modified based on collected user data. A first electronic game that uses first content is hosted during a first time period. Data that is based on actions of users playing the first electronic game is collected. Second content is automatically generated based on the first content and the collected data. A second electronic game is hosted during a second time period. The second electronic game uses the second game content.

Still another aspect is a system that hosts electronic games. That system comprises a processor and a computer readable medium coupled to the processor. The computer readable medium has stored thereon a set of instructions which, when executed on the processor, cause the processor to host electronic games as follows. A first time period is indicated during which an episode of an electronic game that comprises questions is to be hosted. The episode of the electronic game is hosted to client devices during the first time period. Responses to the questions are collected from the client devices. A second time period is indicated during which a rerun of the episode of the electronic game is to be hosted. The rerun of the episode is generated based on the responses. The rerun of the episode of the electronic game is hosted to client devices during the second time period. Note that aggregated data (e.g., data collected from previous episodes or new data generated from previous game play) may be used to simulate the actions of players that do not exist, giving the feel of a game session that is much larger than it actually is.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary entertainment system in which various embodiments described herein can be implemented.

FIG. 2 is a flowchart of one embodiment of a process of modifying an electronic game in order to provide a fresh game experience.

FIG. 3 is a flowchart of one embodiment of a process of automatically generating new game content for an electronic game based on user actions when playing a first episode of the game.

FIG. 4 is a flowchart of one embodiment of a process of developing user-generated content based on user responses to a question in an original episode.

FIG. 5 is a flowchart of one embodiment of a process of generating a rerun of a first episode of an electronic game based on user responses to questions in the original episode.

FIG. 6 is a flowchart of one embodiment of a process of augmenting user responses from an episode currently being hosting by the game server with user responses to an episode that was previously hosted.

FIG. 7 is a flowchart of one embodiment of a process of developing a rerun of a performance-based game.

FIG. 8 depicts an exemplary electronic game console.

FIG. 9 is a block diagram for an embodiment of a computing environment for implementing the present technology.

### DETAILED DESCRIPTION

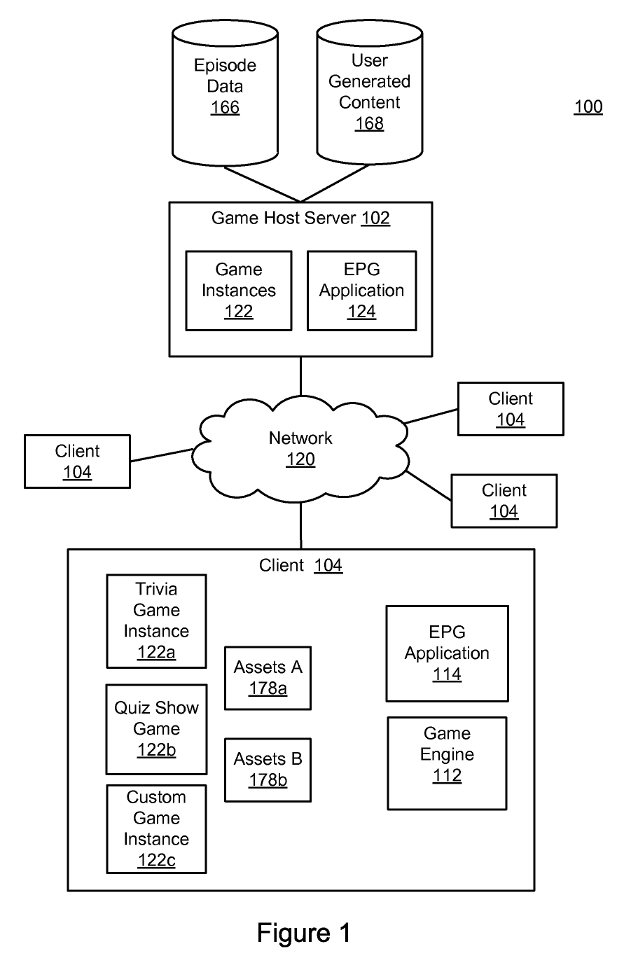

FIG. 1 illustrates an exemplary entertainment system 100 in which various embodiments described herein can be implemented. The system 100 includes a game host server 102 connected to a network 120 to allow users controlling the client devices 104 to play electronic games that are hosted by the game server 102. In one embodiment, a particular game has multiple “episodes” that are hosted by the game server 102 at different times. For example, a trivia game has a season of 10 episodes that are hosted every Wednesday at 9 pm for 10 weeks. The trivia game might have a basic structure in which players are divided into two teams that compete against each other by answering trivia questions. Each episode of the game might be divided into five rounds of questions in different categories. However, each episode a new set of questions is asked, possibly in different categories. There may be other variations from one episode to the next, such as a different celebrity guest that acts as a host or contestant. However, the basic structure of the trivia game remains the same for each episode.

Each of the episodes has an associated game instance 122 that is stored in the game server 102. Each game instance 122 includes software code for playing a particular episode of a game. The software code may be written in a scripting language, although this is not required. As an example, for the trivia game the software code defines the basic structure of five rounds of questions previously discussed. Note that the software is not necessarily exactly the same for each episode, although substantial portions of the code are typically re-used.

Each game instance 122 may be associated with certain data content, such as questions, answers, video clips, audio clips, etc. The data content is stored in the episode database 166. Note that the data content to be used for a particular game instance 122 can be determined “on-the-fly.” For example, the questions to be asked during a given episode can be pulled from the episode database 166 based on what category of questions the players selected. Alternatively, the questions for a given episode can be pre-determined. In this latter case, the game instance 122 could have links to pre-determined questions in the episode database 166. Also, note that the data content can be generated at the time an episode is hosted. For example, in order to allow a celebrity to have a certain amount of interaction with the players, a celebrity could act as a live game host. A recorded of the celebrities' actions can be stored in the episode database 166 for re-use when the episode is rerun. Alternatively, the rerun of the game might not use a live host.

A significant amount of cost and effort may go into developing the different episodes in the series. The effort could go into developing new data content in the episode database 166, new code for the game instances 122, or both. As an example, substantial effort may go into developing new film clips to be used during the new episode or new questions/answers. Thus, much of the effort may go into developing the episode database 166. Note that while portions of the software code in the game instances 122 can be re-used in different game instances 122, in some cases a software programmer will spend considerable time and effort to write and test new software for each new game instance 122.

As the foregoing discussion indicates, the original episodes are based on some limited set of software and data content. In order to make the most of the limited software and data content, “reruns” of the original episodes are created. A rerun is based on an original episode, but alters the electronic game in some way to keep the experience fresh. The electronic game could be altered by automatically modifying the flow of the software, modifying the data content, generating new data content, and/or generating new software. Thus, the game material (e.g., game instances 122 and data in episode database 166) that is used for 10 original episodes can be used for many reruns. This allows a limited amount of game material to be “re-purposed” to create many reruns. For example, responses that users at the clients 104 provided when the original episode was played are collected. Then, based on those responses a new set of questions are automatically derived for the rerun. An example of a new set of questions is to ask the rerun audience how the original audience likely responded to certain questions.

Note that there is no need for a user to manually create the new game material. For example, there is no need for a user to manually add new questions to the episode database 166. Moreover, a software programmer is not required to develop new code for each new game instance 122. Rather, the new version of the episode is automatically generated based on existing material. Note that a programmer might write code that automatically generates new game instances. However, this code can be re-used to generate many new game instances. Further, note that there are many other ways to modify the original game material to make the rerun a fresh experience. For example, it is not required that the new material be derived from responses to questions collected during the original game playing.

In one embodiment, the game server 102 hosts the different episodes at pre-determined times similar to how television programs are broadcast at set times. The game server 102 has an electronic program guide (EPG) application that provides the clients 104 with a schedule that indicates when the different game instances 122 will be hosted. As an example, the game server EPG application 124 provides a program grid that is somewhat similar to a program guide used for television programs. Note that the game host server 102 can be implemented with many servers. For example, there could be a single EPG server and multiple game servers. However, for simplicity a single server is depicted in FIG. 1.

In one embodiment, data pertaining to user interactions when playing a game is collected by the game server 102. As an example, the game server 102 sends messages to the clients 104 requesting answers to questions. The users at the clients 104 provide answers by any variety of user input devices. The game server 102 analyzes the responses and stores user generated content (UGC) in database 168 based on the user responses. In one embodiment, the UCG is used to help generate reruns of games. For example, the game server 102 has a software program that accesses the questions that were asked during the original hosting of the game and the user's responses to the questions. Based on this information, the game server 102 automatically generates a new set of questions and answers to be used in the rerun. An example of a new question is, “what percentage of the previous players correctly predicted what actress would win the Oscar for best actress.” Another example automatically generated question has a question format, “what was the most popular response to a multiple choice question.”

The clients 104 have a game engine 112, which is a software program that serves as a runtime environment for the electronic games. An example of a runtime environment that is suitable for running electronic games is the Adobe® Flash® Player. However, the game engine 122 can be propriety software that is developed specifically for playing electronic games to be hosted by the game server 102.

The clients 104 have instances 122a, 122b, 122c of the games to be played on the client 104. The client 104 may download the game instances 122a-c from the game server 102 in advance of the time the game is hosted and store them in, for example, a hard drive for later use. Alternatively, a game instance 122 may be downloaded from the game server 102 at the time the game is hosted. In this latter example, the game instance 122 might reside only in random access memory for approximately the duration of the game play and not be stored to a hard drive. The example client 104 has downloaded a trivia game instance 122a, a quiz show game instance 122b, and a custom game instance 122c. Each of these instances 122a-c contains the program code for one episode of a particular game.

In addition to the game instances 122a-c, the clients 104 have data content 178a, 178b that is to be used when playing the games. The content 178a-b is used by the game instance 122a-c at appropriate times based on the game flow. If it is known ahead of game play which content from the episode database 166 is going to be used (or if the potential set of content not too large), then the content may be downloaded ahead of time and stored on the client 104. However, the content could be downloaded to the client 104 during game play. Thus, the content is not necessarily stored at the client 104.

The clients 104 have an EPG application 114 to access the program guide from the game server 102. Therefore, the users are able to determine when each episode will be hosted. The clients 104 use data from the EPG to determine which game data to use for each episode.

The clients 120 interact with the game server 102 through the network 120. The communication network 120 can include various wired, wireless, satellite communication arrangements including, but not limited to, a wide area network such as the Internet, a local area network, a cellular phone network under various communication protocols such as 2G, 2.5G and 3G, Global System for Mobile Communications (GSM), General Packet Radio Service (GPRS), EDGE, Code Division Multiple Access (CDMA), Wideband CDMA, TD-SCDMA, Universal Mobile Telecommunications System (UMTS), etc., and Wi-Fi wireless communication standards such as IEEE 802.11, Wi-Max, and IEEE 806.16, and others.

In one embodiment, the game server 102 controls the game flow by sending messages over the network 120 to the clients 104 to direct which code paths should be executed by the game engine 112. The messages can also indicate which data content should be used to play the game. In one embodiment, the game engine 112 interfaces with the game server 102 through an API (not depicted).

The client devices 104 can include personal computers, portable digital assistants (PDA), cellular telephones, network enabled music players, digital versatile disk (DVD) players, set top boxes, or dedicated game devices such as Microsoft Xbox™, Microsoft Xbox 360™, Sony PlayStation™, Sony PlayStation™ 2, Sony PlayStation™ 3, and Nintendo Wii™.

In one embodiment, the game server 102 and/or client devices 104 execute computer readable instructions that are stored on computer readable media. The game server 102 and client devices 104 each have at least one processor on which the instructions are executed. Computer readable media can be any available media that can be accessed by the game server 102 and client devices 104. By way of example, and not limitation, computer readable media may comprise computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, flash drives, console memory units, or any other medium which can be used to store the computer readable instructions and which can accessed by the game server 102 and client devices 104.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

It is to be appreciated and understood that the exemplary system 100 constitutes but one exemplary operating environment. Accordingly, this description is not intended to limit application of the claimed subject matter to just this one type of operating environment. Rather, the principles described herein can be implemented in other similar or different environments without departing from the spirit and scope of the claimed subject matter.

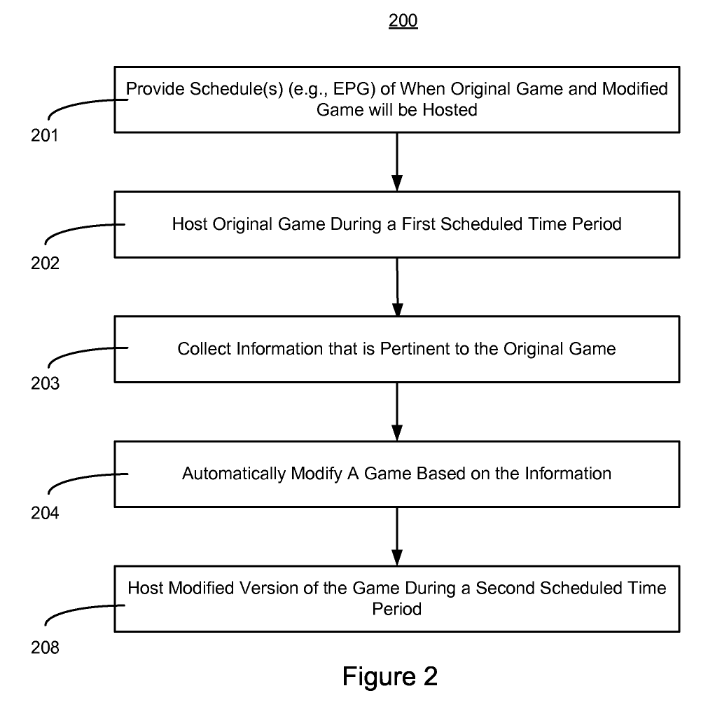

FIG. 2 is a flowchart of one embodiment of a process 200 of modifying an electronic game in order to provide a fresh game experience for a rerun of an episode of the electronic game. Process 200 may be performed by executing instructions on a processor. In one embodiment, process 200 is performed by the game server 102. In step 201, the game server 102 provides one or more schedules that indicate when an original episode of an electronic game will be hosted and when a modified electronic game will be hosted. In one embodiment, the modified game is a rerun of the original episode. In one embodiment, the schedule(s) are provided as an EPG grid. The EPG includes all games to be hosted over the next two weeks, for example. It not required that a single schedule include both the original episode and the rerun.

In step 202, the game server 102 hosts an original episode of an electronic game to whatever clients 104 connect to the game server 102. By acting as a host, the game server 102 coordinates the game play amongst the different clients 104. For example, the game server 102 might stream video to the clients 104 or send messages directing the clients 104 which data assets stored on the clients 104 should be used at a particular time.

The original episode may be one episode in a series in which each episode provides a unique game experience. For example, each episode might ask the players a different set of questions or test the players' skill in different performance tests. Note that the total game content of the series is limited. Moreover, typically substantial effort and cost goes into developing the game content for the episodes.

In step 203, the game server 102 collects information that is pertinent to playing the original electronic game. Step 203 could include tracking user interactions such as users' response to questions or performance during a performance game. Step 203 could also include monitoring game flow by, for example, tracking which code paths in the game instance 122 are taken. Note that the game flow may be a result of user decisions, such as selecting a certain category of questions to answer. Examples of other information that might be collected includes but is not limited to player provided input such as a question, comment, or some creative content such as a video file.

In step 204, the game server 102 or other computing device automatically modifies an electronic game based on the information collected in step 203. In one embodiment, it is the original episode of the game that is modified. Thus, a rerun that is somehow different from the original episode is created. However, step 204 could involve modifying an episode of the electronic game other than the original episode from step 202. For example, episode 9 of a trivia game can be modified based on data collected from playing episode 2. In one embodiment, the modification is to a different electronic game. For example, the content of a trivia game could be modified based on data collected from the playing of a game in which players attempt to guess the prices of products.

In one embodiment, the modification of step 204 is to automatically generate new content based on the original content. For example, new questions are automatically generated from old questions. Answers to the new questions may be based on user responses to the old questions. Another example is to form questions that have the players guess what happened when the game was previously played. As another example, a video, question, or comment provided by a user in step 203 is used for new game content. For example, a user-supplied video is inserted into an appropriate point of the game flow.

In one embodiment, the modification is related to how the game flows. For example, if the players' actions caused the game to flow down one code path during the original episode, then the modification could be to force game play down a different code path. For example, if the players cause a set of history questions to be asked during the original episode, the path that pulls history questions from the episode database can be avoided during the new game flow. By forcing different instructions in the electronic game to be executed, the game experience is kept fresh. As another example, the game server 102 could force the game flow down the same code paths that were taken during the original game play. For example, the game flow is forced to the same category of questions in a trivia game. However, to keep the experience fresh, a different set of questions within the category might be asked. The electronic game might be modified in other ways, as well.

In step 208, the game server hosts 102 hosts the game that was modified in step 204 during a second scheduled time period. Note that by automatically modifying the game, a fresh game experience is created without a producer having to manually develop more content. For example, a user does not need to create new video clips or modify questions in an XML file. Thus, the users who play the variation receive a fresh game experience. Moreover, the original episode (game instance 122 and associated data in the episode database 166) is used as a base to generate the fresh game experience.

Note that in some embodiments, the automatic modification to the electronic game (step 204) is performed while the game is being hosted in step 208. For example, the code in the game instance 122 could have a decision point at which one of two or more code paths can be taken. The decision as to which path to take could be made while the game is being hosted in step 208.

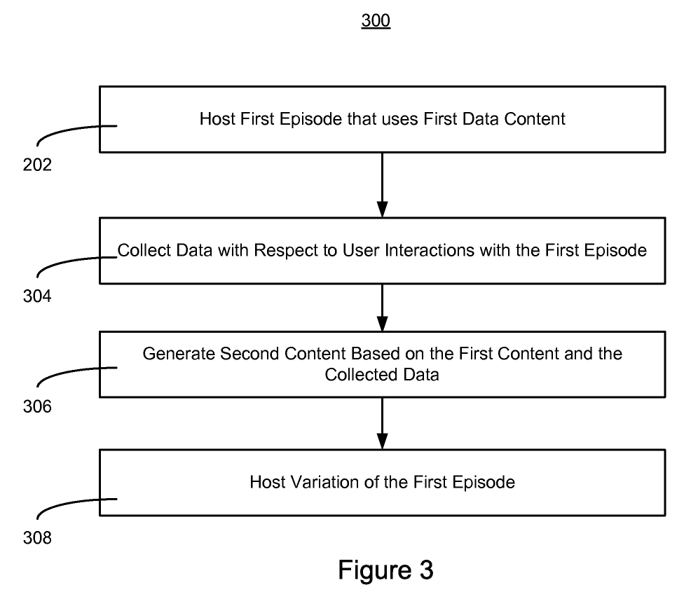

FIG. 3 is a flowchart of one embodiment of a process 300 of automatically generating new content for an electronic game based on user actions during a first episode of the game. The new content can be used for a rerun of the first episode. In one embodiment, process 300 is performed by the game server 102. Process 300 is similar to process 200, but in a special case in which new game content is created based on old content and information that is collected based on user interactions in previous game play.

In step 202, the game server 102 hosts a first episode of an electronic game. This could be one of the original episodes in a series, but that is not a requirement. For example, after a new game instance 122 is automatically developed from an original game instance 122, that new game instance 122 can serve as a base for automatically developing yet another game instance 122.

In step 304, the game server 102 collects data pertaining to user interactions when playing the game. Examples of user interactions include, but are not limited to, responses to questions and performance metrics. An example of a performance metric is how close the pitch of the user's voice is to a reference pitch. This performance metric might be collected in a karaoke game. Step 304 is one technique for implementing step 203.

In step 306, the game server 102 automatically generates new content based on the aggregated data and the first content. The new content is stored in the UGC database 168. As an example, the game server 102 has a software program that automatically generates a new set of questions that are based on questions in the first episode and the user's responses to the questions. Thus, the original content is re-used in a different manner than in the first episode in order to provide a fresh experience. Note that the software program that is used in step 306 can be re-used to generate new questions for many different episodes. Moreover, the software could even be used for different games. Step 306 is one technique for implementing step 204. In step 308, the new version of the game is hosted by the game server 102.

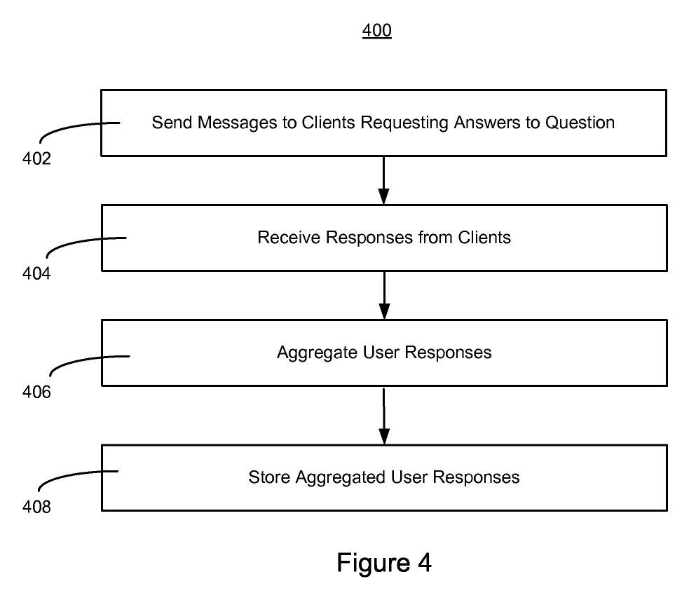

FIG. 4 is a flowchart of one embodiment of a process 400 of developing aggregated data based on user responses to a question in an original episode. The aggregated data can be used to generate UGC. Process 400 covers processing a single question and may be repeated for each question. Steps 402 and 404 are one technique for implementing the data collection (step 304) of process 300 and are performed when the game server 102 hosts a game.

In optional step 402, the game server 102 issues messages to the clients 104 requesting responses to questions. This message may or may not include the question itself. For example, the question might already be stored at the clients 104; however, the message prompts the clients 104 to send a response and indicates to where the response should be sent. Step 402 is not a requirement in that the code in the game instances 122 on the clients 104 can automatically prompt the users for responses to questions and forward the responses to the game server 102.

In step 404, the clients 104 provide responses to the questions. In one embodiment, the game instance 122 causes a question to be presented on the client device 104 by accessing a file from either content A 178a or content B 178b. The file could contain information used to render a still image or a video image on a display coupled to the client 104. As an example, the user is presented with a multiple choice question and instructions with how to input their response. The user input is then forwarded over the network 120 to the game server 102. In one embodiment, the game server 102 sends the question to the clients 104.

In step 406, the game server 102 aggregates the responses from the clients 104. Note that the data can be aggregated in a wide variety of ways. For example, if the game might is structured as a contest between two or more teams, the response of each team can be kept separate. Other techniques could be used to aggregate the data.

In step 408, the game server 102 stores the aggregated data, which can be used later when automatically forming new questions for a rerun episode. As an example, the game server 102 determines the percentage of users that selected each choice of a multiple-choice question and stores that percentage. Thus, the game server 102 does not need to store all of the user responses, although the user responses could be stored.

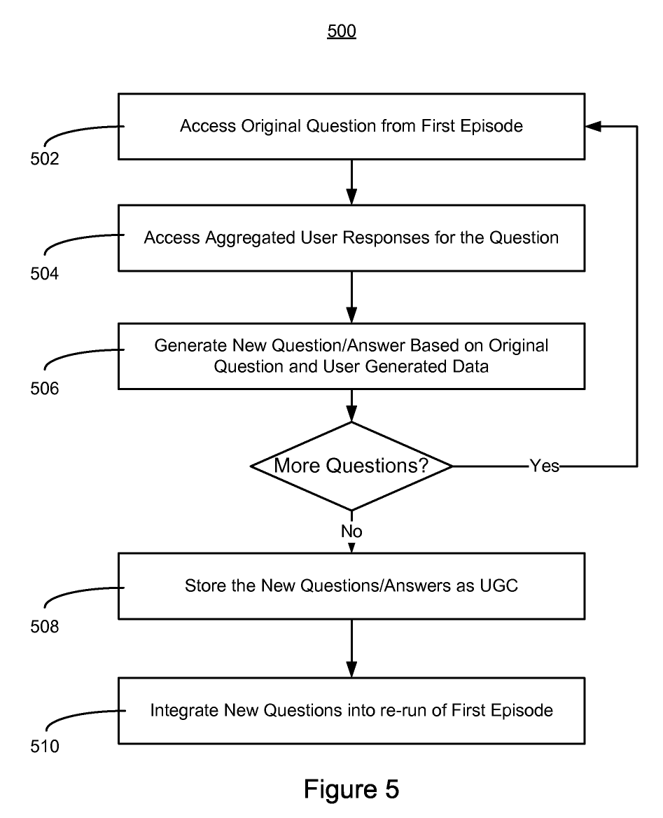

FIG. 5 is a flowchart of one embodiment of a process 500 of generating a rerun of a first episode of an electronic game based on user responses to questions in the original episode. Process 500 may be performed after storing aggregated user responses as described in process 400 of FIG. 4. However, the aggregated responses used by process 500 can be generated by a technique other than process 400. Process 500 is one technique for implementing step 204 of process 200. In step 502, the game server 102 accesses an original question from a first episode. The first episode refers to an episode that was previously hosted and that serves as a base for the new episode to be generated by process 500. In one embodiment, the original game instance stores a reference that points to the question or to a series of questions in the episode database 166. A software program can be written to automatically read the reference in the game instance and use the reference to obtain the question(s) from the database.

In step 504, the game server 102 accesses aggregated user responses to obtain data pertaining to how the users responded to question from step 502. When the aggregated responses that are based on the question were stored, aggregated responses are tagged with an identifier of the question such that they can later be connected back to the question. Note that aggregated responses for a single question can have many components. For example, the aggregated responses might include the percentage of players in each category that answered the question a certain way.

In step 506, one or more new questions (and suitable answers) are automatically generated based on the original question and the user's responses. In one embodiment, the game server 102 has software that automatically generates the new questions and answers. If desired, another question from the first episode is processed by returning to step 502. When all the desired questions have been processed, control passes to step 508 to store the newly generated questions and answers in the UGC database 168.

In step 510, the new questions are integrated into a rerun of the original episode. The integration of the new questions can be achieved by forming a new game instance 122 with links in the new game instance to the new questions stored in the UGC database 168. In one embodiment, the new game instance 122 is automatically generated by software. The new game instance 122 is then stored on the game server 102. The game server 102 includes information about the rerun in the EPG, such that players can determine whether they are interested in playing the rerun episode. For example, the EPG can provide selected details such as the original airdate and high-level details of the subject matter of the questions. Interested players can download the game instance to their client device 104.

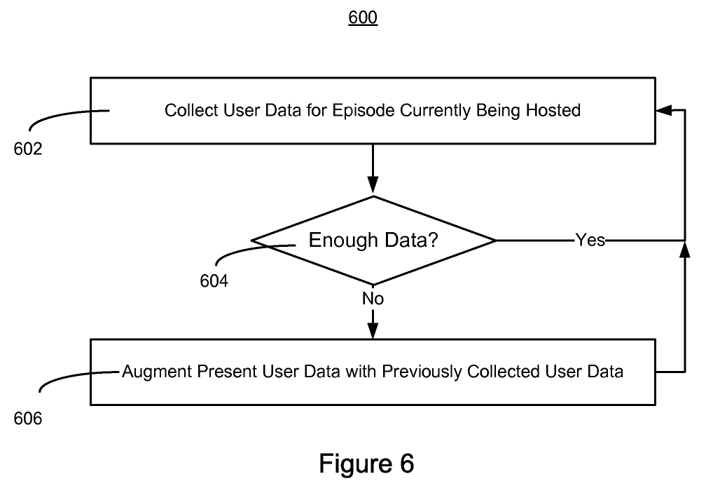

FIG. 6 is a flowchart of one embodiment of a process 600 of augmenting user data collected from an episode currently being hosted by the game server 102 with user data collected during a previous hosting of a similar episode. Process 600 can be used when a rerun that is currently being hosted does not have a large enough audience for the user responses to “scale properly.” For example, the game server 102 might report the user's answers based on categories. If there are not enough users in a given category, the data from the rerun can be augmented with previously collected data.

Process 600 describes steps that are performed during the hosting of the rerun. Note that this rerun could use the same game instance 122 and the same content from the episode database 166 as the original episode. However, because it is a rerun the episode might be expected to have a smaller number of players. Process 600 assumes the existence of some data collected from a first hosting of a first episode upon which the rerun is based. As an example, the data could describe the percentage of players that selected a given answer. Note that the rerun does not need to present that exact same content to the users as the first episode. For example, the rerun could ask the user some questions that were automatically generated from previous episodes. Moreover, the rerun might be based on more than one episode. For example, the rerun could be based on questions taken from more than one episode. Process 600 is one technique for implementing step 204 of process 200 of modifying an episode based on previously collected information.

In step 602, the game server 102 collects user data during the hosting of the rerun episode. In step 604, the game server 102 determines whether the volume of data collected is sufficient for some purpose. As an example, there might not be enough players on each team of a multi-team game; however, there could be many other reasons why more data is desired. In one embodiment, the more data that is used the more statistically accurate the simulated play will be. Therefore, the game server 102 determines that regardless of how much data is collected it is not sufficient.

If there is not sufficient data, then control passes to step 606. In step 606, the game server 102 augments the present user data with previously collected user data. For example, if the game may be a competition between players in different groups. If there are not enough players online for a given group, then that groups data is augmented with responses from one or more previous episodes.

After augmenting the data, control passes to step 602 to collect additional user data, such as responses to another question. If at step 604 it was determined that there is sufficient data, then control passes to step 602 without augmenting the currently collected data.

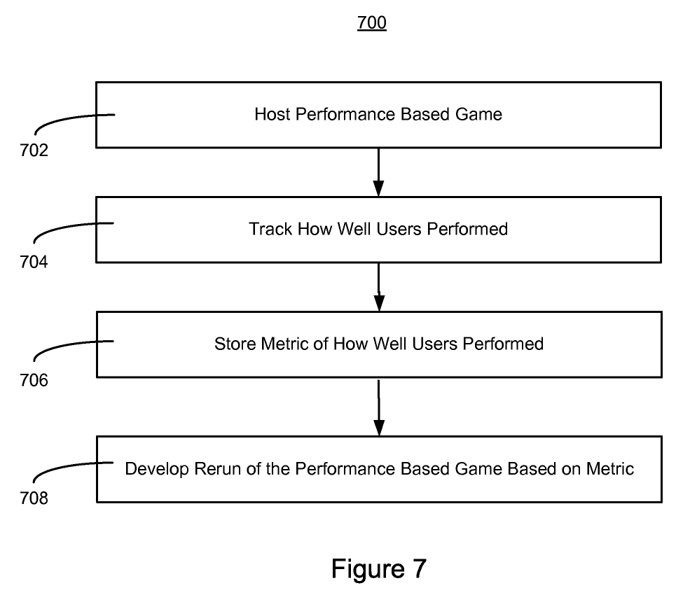

FIG. 7 is a flowchart of one embodiment of a process 700 of developing a rerun of a performance-based game. As an example, a karaoke game could test a player's ability to sing at the proper pitch. Another game could test a player's ability to mimic playing a musical instrument. Process 700 includes steps that are performed during a first hosting of a performance-based game and steps afterwards to automatically develop a new game based on the game played during the first hosting. The original hosting of the game is performed by the game server 102. The steps of automatically developing the new game may be performed by the game server 102 or another computing device. Process 700 is one technique for automatically modifying an episode based on previously collected information, as discussed generally in connection with process flow 200 of FIG. 2.

In step 702, the game server 102 hosts a performance based game during a first time period. In one embodiment, the game server 102 provides a schedule that indicates when the performance based game will be hosted.

In step 704, the game server 102 tracks how well the players performed when playing the performance based game. As an example, each player sings into a microphone attached to his or her client device 104. The goal of the player it to match a reference frequency. Software on the client device 104 determines the frequency of the player's voice. The client device 104 sends a message to the game server 102 indicating how close the player was to the reference frequency. As another example, the game could have a celebrity performer whose performance is streamed to each of the client devices 104. In this example, the game server 102 might analyze how close the celebrity came to the reference frequency and store that information. Step 704 is one technique for implementing step 203 of process 200.

In step 706, a metric is stored based on the information collected in step 704. The metric could be an aggregation of the collected data, such as the percentage of users who had perfect pitch, those who were off by 1-3 Hertz, etc. In one embodiment, the metric is stored in the UGC database 168.

In step 708, a rerun is developed based on the data stored from step 706. An example rerun is to test the players in the same performance test, but the goal is now to beat the celebrity performance from the original hosting of the game. For example, in the first hosting of the game, a celebrity tried to sing in pitch and the players at the client devices 104 predicted how well the celebrity would do. In the rerun, the user's attempt to sing in pitch and are graded on how well they did compared to the celebrity. As another example, in the re-run the players vote on how well the players in the original game performed.

The technology described herein is operational with numerous other general purpose or special purpose computing system environments or configurations. Examples of well known computing systems, environments, and/or configurations that may be suitable for use with the technology herein include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

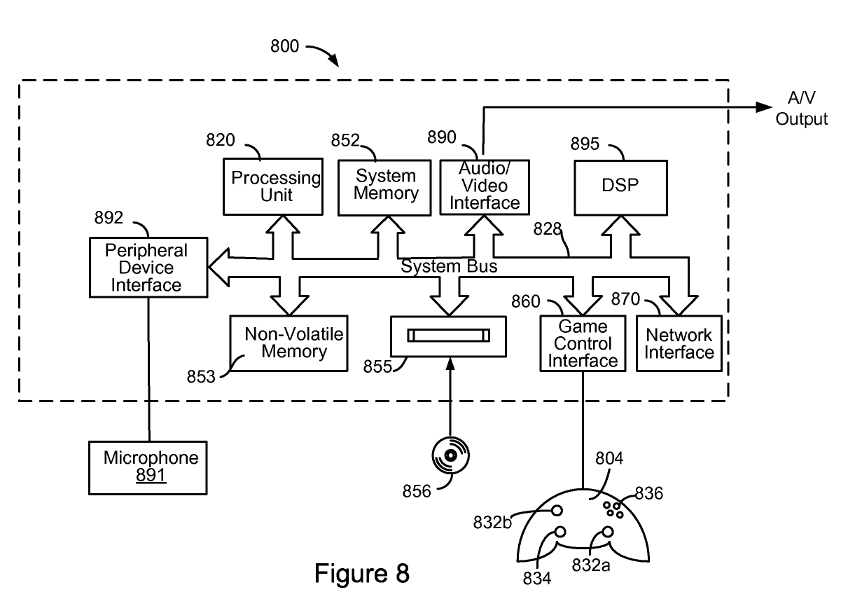

FIG. 8 depicts an exemplary electronic game console 800. The game console 800 may be used to implement a client device 104. With reference to multiplayer game console 800, several key functional components are shown, although it should be understood that other functional components are also included, but not shown. Specifically, game console 800 includes a central processing unit (CPU) 820, system memory 852 that may include read only memory (ROM) and random access memory (RAM). Non-volatile memory 853, which may include hard drives, magnetic tape cassettes, flash memory cards, digital versatile disks, digital video tape, solid state RAM, solid state ROM, etc. Also provided is a DSP 895. In one embodiment, the DSP 895 process signals from a microphone 891, which connects to the peripheral device interface 892.

Game console 800 is equipped with a portable media drive 855 that supports various forms of portable optical storage media, as represented by an optical storage disk 856. Examples of suitable portable storage media include DVD disks and CD-ROM disks. In this gaming system, game programs may be distributed for use with the game console 800 on DVD disks, but it is also contemplated that other storage media might instead be used, or that games and other programs can be downloaded from a gaming site over the Internet (or other network).

Game console 800 connects to a television or other display monitor (not depicted) via audio/video interface 890. Game console 800 has a network interface 870 to transfer data. The network interface could connect through an Ethernet connection to the network 120 and/or through a broadband connection to the network 120 (e.g., the Internet). Alternatively, it is contemplated that a modem (not shown) may be employed to transfer data to the network 120. As yet a further alternative, the game console 800 can be directly linked to another game console 800 via an Ethernet crossover cable (not shown).

The game console 800 supports multiple user input devices, such as controller 804. The controller 804 is coupled to game control interface 860 via a lead or a wireless interface. In one implementation, the controller 804 is Universal Serial Bus (USB) compatible and is connected to game console 800 via a USB cable. Game console 800 may be equipped with any of a wide variety of user devices for interacting with and controlling the game software. The controller 804 is equipped with thumb sticks 832a and 832b, a D-pad 834, and buttons 836. The controller 804 is merely representative and other gaming input and control mechanisms may be substituted.

Removable function units or modules can optionally be inserted in to game controller 804 to provide additional functionality. For example, a portable memory unit (not shown) enables users to store game parameters and port them for play on another game console 800 by inserting the portable memory unit into a controller 804 on the other console 800. Other removable function units, such as an alphanumeric keypad, are also available for use with the controller.

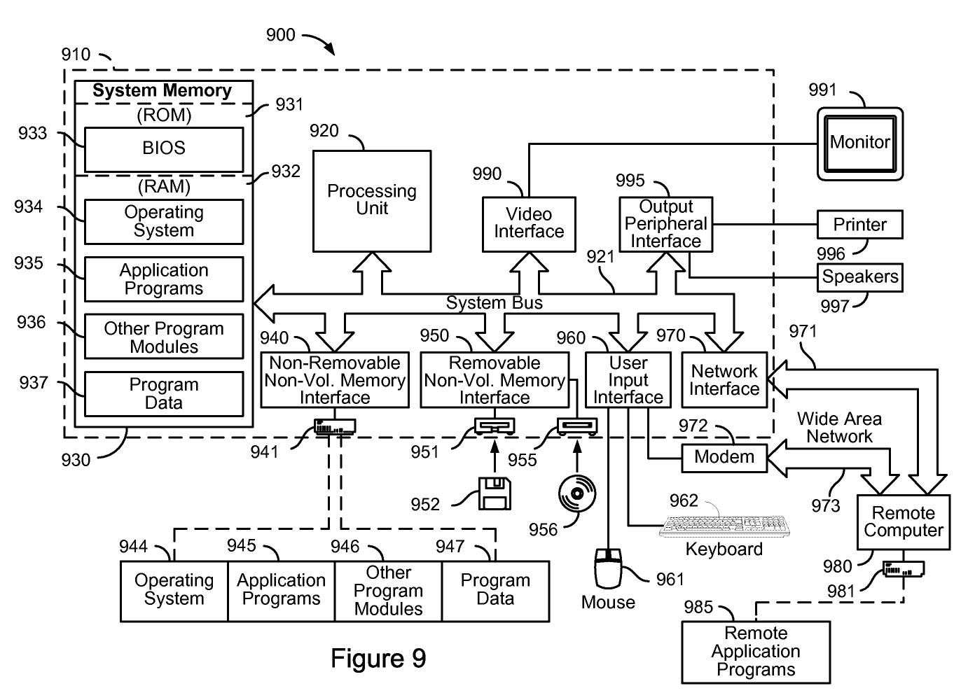

FIG. 9 is a block diagram for an embodiment of a computing environment for implementing the present technology. In some embodiments, the computing environment of FIG. 9 may be used to implement server 102 and/or client 104 of the system of FIG. 1. Computing environment 900 of FIG. 9 is only one example of a suitable computing environment and is not intended to suggest any limitation as to the scope of use or functionality of the technology herein. Neither should the computing environment 900 be interpreted as having any dependency or requirement relating to any one or combination of components illustrated in the exemplary operating environment 900.

With reference to FIG. 9, an exemplary system for implementing the technology herein includes a general-purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 90 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). Optionally, a monitor 991 or other type of display device may also be connected to the system bus 921 via an interface, such as a video interface 990. In addition to the monitor, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically has an external modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A machine implemented method comprising:
hosting a first electronic game over a network to client devices;
collecting information that is pertinent to playing the first electronic game, the information is collected while hosting the first electronic game;
automatically determining a modification to a second electronic game based on the information; and
hosting a third electronic game over a network, the third electronic game is based on the modification to the second electronic game.

2. A method as recited in claim 1, wherein the first electronic game and the second electronic game are the same electronic game.

3. A method as recited in claim 1, wherein the first electronic game comprises a series of questions and the collecting information includes collecting responses from the client devices to the series of questions.

4. A method as recited in claim 3, wherein the automatically determining a modification to the first electronic game includes generating a set of questions and answers that are based on the responses from the client devices to the series of questions.

5. A method as recited in claim 1, wherein the first electronic game comprises a performance test and the collecting information includes measuring how well users at the client devices performed on the performance test.

6. A method as recited in claim 1, wherein the first electronic game includes a first data set and the automatically determining a modification to the first electronic game includes:
automatically selecting a second data set for use with the second electronic game, the selecting is based on how the client devices play the first electronic game.

7. A method as recited in claim 1, wherein the first electronic game includes program code and the automatically determining a modification to the first electronic game includes selecting which portion of the program code should be executed when playing the second electronic game.

8. A method as recited in claim 7, wherein the collecting information includes tracking which portions of the program code were executed during the hosting of the first electronic game.

9. A method as recited in claim 8, wherein game play associated with a first path in the program code is based on first data and the selecting which portion of the program code should be executed when playing the second electronic game includes selecting the first path for execution but basing game play on second data.

10. A method as recited in claim 8, wherein the program code includes a first path that was not taken when hosting the first electronic game and the selecting which portion of the program code to execute includes selecting the first path for execution when hosting the second electronic game.

11. A machine-implemented method as recited in claim 1, wherein hosting a first electronic game includes hosting the first electronic game during a first scheduled time period and hosting the second electronic game includes hosting the second electronic game during a second time period.

12. A machine implemented method comprising:
hosting a first electronic game during a first time period, the first electronic game uses first content;
collecting data that is based on actions of users playing the first electronic game during the first time period;
generating second content based on the first content and the collected data; and
hosting a second electronic game during a second time period, the second electronic game is a variation of the first electronic game that uses the second content.

13. A method as recited in claim 12, further comprising:
providing at least one schedule that indicates that the first electronic game is to be hosted during a first time period and that indicates that the second electronic game is to be hosted during a second time period.

14. A method as recited in claim 12, wherein the first electronic game comprises a series of questions and the collecting data includes:
sending messages to client devices during the first time period, the messages request responses to questions included in the first electronic game; and
collecting responses to the questions from the clients.

15. A method as recited in claim 12, wherein the data is first data and the generating second content includes:
collecting second data during the second time period, the second data is to be used in playing the second electronic game;
determining that the second data is insufficient for the second electronic game; and
augmenting the second data with the first data.

16. A method as recited in claim 12, further comprising providing one or more schedules that indicate the first time period in which the first electronic game is to be hosted and the second time period in which the second electronic game is to be hosted.

17. A system comprising:
a processor; and
a computer readable medium coupled to the processor and having stored thereon a set of instructions which, when executed on the processor, cause the processor to perform:
indicating a first time period during which an episode of an electronic game is to be hosted;
hosting the episode of the electronic game to a first plurality of client devices during the first time period, the game comprises a plurality of questions;
collecting responses to the questions from the first plurality of client devices;
indicating a second time period during which a rerun of the episode of the electronic game is to be hosted;
generating the rerun of the episode based on the responses; and
hosting the rerun of the episode of the electronic game to a second plurality of client devices during the second time period.

18. A system as recited in claim 17, wherein the generating the rerun of the episode based on the responses includes automatically determining a new set of questions and answers based on the questions and the responses to the questions.

19. A system as recited in claim 17, wherein the computer readable medium contains instructions that when executed on the processor provide an electronic program guide (EPG) to indicate when the episode of the game and the rerun of the episode are to be hosted.

20. A system as recited in claim 17, wherein the system stores a plurality of episodes of the electronic game.
